(19) United States
(12) Patent Application Publication
(10) Pub. No.: US 2012/0303178 A1
(43) Pub. Date: Nov. 29, 2012

(54) METHOD AND SYSTEM FOR ESTABLISHING USER SETTINGS OF VEHICLE COMPONENTS

(76) Inventors: Jeffrey C. Hendry, Waterford, MI (US); Michael Mashkevich, West Bloomfield, MI (US)

(21) Appl. No.: 13/116,510

(22) Filed: May 26, 2011

(51) Int. Cl. G06F 17/00

(52) U.S. Cl. 701/2

(57) ABSTRACT

A system and method for reinstating settings of at least one vehicle component of a vehicle is disclosed. A request to establish a communications link between a communications module of the vehicle and an external device associated with a user of the vehicle from the external device is received by a communications module. Based on the request to establish the communications link, the settings of the at least one vehicle component of the vehicle a retrieved from a data store associated with the at least one vehicle component. The settings of the at least one vehicle component are adjusted based on the retrieved settings.

### FIELD OF THE INVENTION

The present disclosure relates generally to a method and system for establishing user settings of vehicle components of a vehicle. In particular, the system retrieves the user settings from at least one data store associated with the vehicle based on a request from an external device to establish a communications link with a communications module of the vehicle.

### BACKGROUND

Many vehicles today allow a user to change the settings of various vehicle components. For instance, a user can adjust various settings, including settings of the seat, settings of the heating, ventilation, and air conditioning system (“HVAC system”), settings of the audio/visual system, settings of the lighting system, settings of the sounds that the vehicle makes, and various other settings.

Furthermore, some vehicles may allow a user to save settings personal to the user. In these vehicles, the user can push a button, e.g. a mechanical switch on the console of the vehicle, and the vehicle settings will be restored to the saved settings personal to the user. One draw back of the foregoing is that the amount of users that can save settings is limited to the amount of buttons in the console. Other vehicles are configured to sense a particular key fob in the vicinity of the vehicle. Upon detecting the key fob, the saved settings personal to the user are restored. One drawback of using the key fob is that a key fob may be used by multiple users, thereby mitigating the convenience of having personal user settings.

### SUMMARY

In one aspect of the disclosure, a method for reinstating settings of at least one vehicle component of a vehicle is disclosed. The method comprises receiving a request to establish a communications link between a communications module of the vehicle and an external device associated with a user of the vehicle from the external device. The method further comprises retrieving settings of the at least one vehicle component of the vehicle from a data store associated with the at least one vehicle component based on the request to establish the communications link, wherein the data store resides in the vehicle. The method also comprises adjusting the settings of the at least one vehicle component based on the retrieved settings.

In another aspect of the disclosure, a system for reinstating settings of at least one vehicle component of a vehicle is disclosed. The system comprises a communications module that receives a request to establish a communications link between the communications module and an external device associated with a user of the vehicle from the external device, and that establishes the communications link between the communications module and the external link. The system further comprises at least one component module that retrieves settings of the at least one vehicle component of the vehicle from a data store associated with the at least one component module based on the request to establish the communications link and that adjusts the settings of the at least one vehicle component based on the retrieved settings. The data store resides in the vehicle

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a partial perspective view illustrating an interior of a vehicle and an external device in communication with a component of the vehicle;

FIG. 2 is a block diagram illustrating exemplary components of a user settings system;

FIGS. 3A and 3B are flow charts illustrating exemplary methods for retrieving the settings of a user;

FIGS. 4A and 4B are flow charts illustrating exemplary methods for storing the settings of a user; and

FIG. 5 is a block diagram illustrating an alternative embodiment of the user settings system.

### DETAILED DESCRIPTION

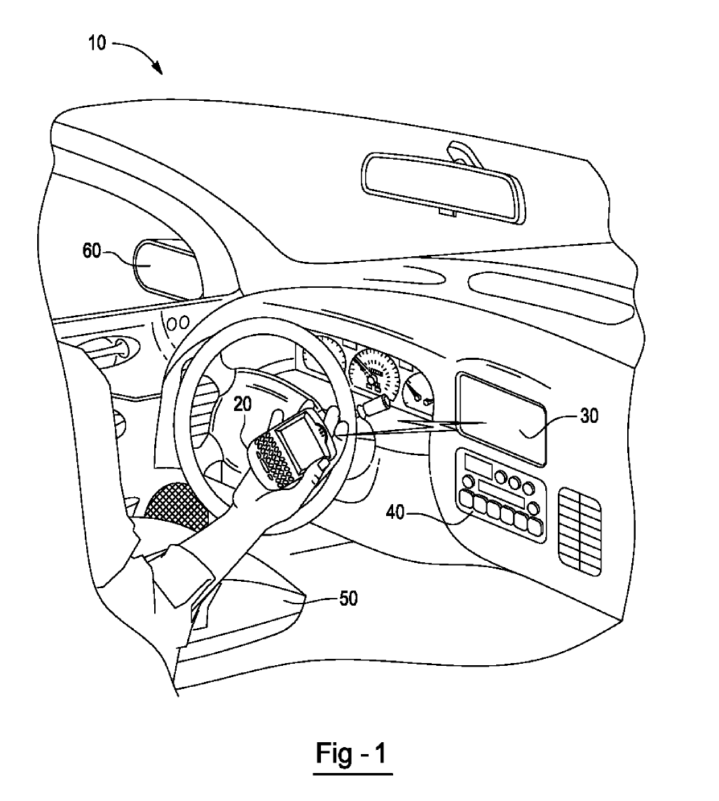

FIG. 1 illustrates an interior cabin of a vehicle 10 having a user settings system. The user settings system is configured to reinstate settings of at least one vehicle component of a vehicle 10, wherein the settings are saved by a user of the vehicle 10. Shown in the vehicle 10 are a number of vehicle components, whose settings may be adjusted. For instance, a user can adjust the settings of the audio/visual system 30 of the vehicle, the HVAC system 40 of the vehicle, one or more of the seats 50 of the vehicle, the lighting system (not shown) of the vehicle, and the mirrors 60 of the vehicle 10. The user settings system reinstates a user's personal settings when an external device 20 associated with the user is detected in the vicinity of the vehicle. Typically, the external device 20 is considered detected when the external device 20 requests that a communications link be established between the external device 20 and a communications module of the vehicle 10.

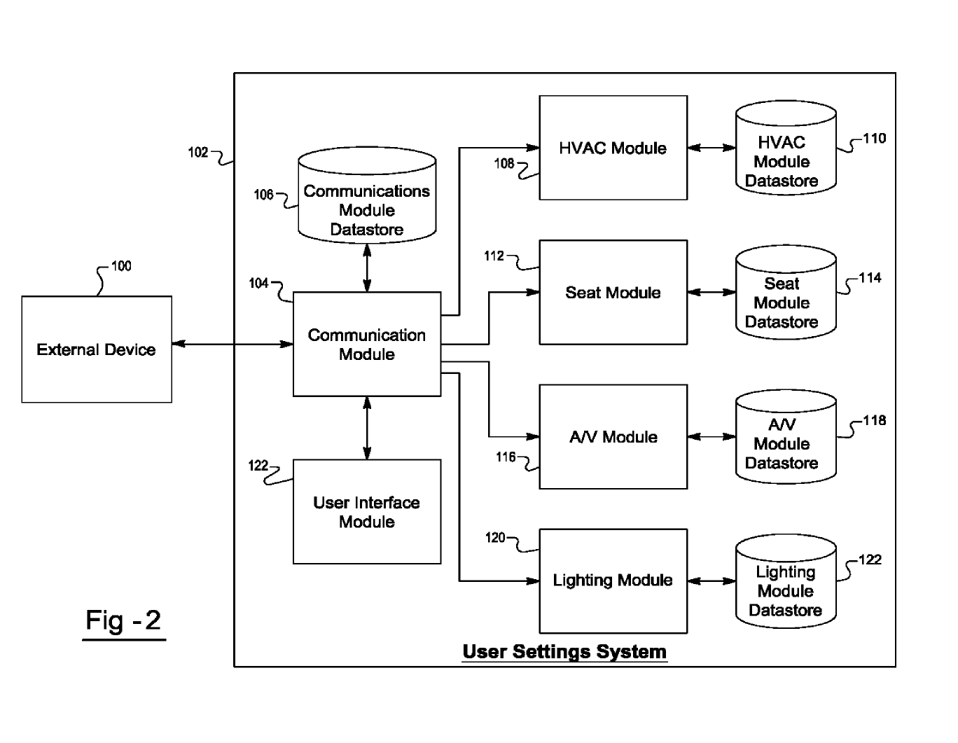

As discussed, one or more users can personalize settings of the various vehicle components and a user settings system can reinstate the personalized settings. FIG. 2 illustrates an exemplary user settings system 102. The exemplary user settings system 102 includes a communications module 104 which establishes communication with the external device 100. To establish a communications link with the communications module 104, the external device 100 transmits a request to the communications module 104 that identifies the external device 100 to the communications module 104. The communications module 104 uses the request from the external device 102 to determine that a user associated with the external device 100 is in the vehicle 10. Based on this determination, the communications module 104 notifies various vehicle component modules, which adjust user settings of the vehicle components, that the user is in the vehicle 10. For instance, the communications module 104 can notify an HVAC module 108, a seat module 112, an A/V module 116, and a lighting module 120 that the identified user or external device 100 is in the vehicle 10. It is appreciated that the set of modules provided are exemplary and it is envisioned that other modules that control settings of vehicle components can be included in the user settings system 102. For instance, a user can specify whether a horn chirp is desired when the doors are locked, whether the dome lights remain on for a predetermined amount of time after the motor of the vehicle 10 is shut off, or whether the windshield wipers are automatically activated upon detection of liquid on the windshield.

Upon receiving notification of the user or the external device 100, each of the modules 104, 112, 116, and 120, will retrieve user settings corresponding to the user or external device 100 from a respective datastore. For instance, the HVAC module 108 will retrieve the HVAC settings of the user from an HVAC datastore 110 associated with the HVAC module 108. The HVAC module 108 will then adjust the settings of the HVAC system 40 in accordance with the retrieved settings.

The components of the user settings system 102 are now described in greater detail. In an exemplary embodiment, the external device 100 is a Bluetooth® enabled mobile telephone 100. It is appreciated that in the exemplary embodiments, the external device 100 can further be a laptop computer, a PDA, an MP3 player, or any other Bluetooth enabled device. One or more users can pair one or more mobile devices, e.g. mobile telephones, to a communications module 104 for the purposes of using a component of the vehicle 10 as a proxy for the mobile telephone 100, e.g. hands free talking. In exemplary embodiments, the communications module 104 is a Bluetooth® receiver. It is envisioned, that the communications module 104 can be any other suitable receiver such as a Zigbee receiver, a wifi receiver, or a wimax receiver. The pairing of the external device 100 to the communications module 104 allows the communications module 104 to later recognize the external device 100 when the external device 100 requests to establish a communications link with the communications module 104. Once a communications link is established, data is transferred via the communications link to the communications module 104 from the external device 100 and to the external device 100 from the communications module 104.

One exemplary application of the communications link established between the mobile telephone 100 and the communications module 104 is hands free talking, wherein the user speaks into a microphone of the A/V system 30 coupled to the communications module 104 during a telephone call. The communications module 104 encodes the user's speech and transmits the digitally encoded voice signals to the mobile telephone 100 via the communications link. The mobile telephone 100 then transmits the encoded voice signals over a communications network to another telephone. Similarly, when the mobile telephone 100 receives encoded voice signals via the communications network, the mobile telephone 100 transmits the encoded signals to the communications module 104, which outputs the received voice signal via speakers of an audio system in the vehicle 10. While the example of hands free talking is provided, it is envisioned that the communications module 104 can be configured to support additional applications and the foregoing is merely provided for a common example of a Bluetooth application.

As discussed, the external device 100 is initially paired to the communications module 104. In embodiments where the communications module 104 operates according to the Bluetooth® protocol, during the pairing state, the communications module 104 will generate and assign a key to the external device 100 and the external device 100 will verify the key. As used herein, the term key refers to any suitable code, password, passcode, or string used to authenticate a device. It is appreciated that any suitable means for generating a key can be used and the key can be formatted in any suitable fashion. The communications module 104 stores the key and a device identifier in a communications module datastore 106. The communications module datastore 106 stores the keys and device identifiers for all external devices 100 paired with the communications module 104. In some instances, the communications module datastore 106 can be further configured to associate a user identity with the device and/or key. Once the key is assigned to the external device 100 and agreed upon by the external device 100 and the communications module 104, the external device 100 and the communications module 104 are considered paired. It is envisioned that any suitable pairing means can be used. For instance, legacy pairing or secure simple pairing can be implemented on the communications module 104.

Once paired, a communications link can be established between the external device 100 and the communications module 104. With respect to a Bluetooth communications link, the external device 100 is typically set to be “discoverable.” When a device is set to be discoverable, another device, e.g. the communications module 104, can detect the presence of the discoverable device. When the communications module 104 detects the presence of the external device 100 it will broadcast a signal via a transceiver associated with the communications module 104 indicating to the external device 100 that the external device 100 can synchronize with the communications module 104. In response to the broadcast, the external device 100 will transmit to the communications module 104 a request to synchronize with the communications module 104. The request will include the key of the external device 100 and a device identifier. The communications module 104 will receive the request and verify and/or authenticate the external device 100. Once verified and/or authenticated, the communications module 104 will establish a communications link between the external device 100 and the communications module 104.

As will be described, the user settings system 102 uses a request from an external device 100 to establish the communications link to determine an identity of the user or the device. In essence, the user settings system 102 piggybacks the request to establish a communications link into a request to reinstate the personal settings of the user associated with the external device 100. In the embodiment depicted in FIG. 2, the communications link receives the request and queries the communications module data store 106 with the device identifier. The communications module data store 106 returns the key. The communications module 104 checks the stored key with the key transmitted by the external device 100 during the request to establish a communications link. If the communications module 104 determines that the keys match, the external device 100 is authenticated.

Once the external device 100 is verified/authenticated, the communications module 104 transmits a signal via a communication bus in the vehicle 10 to at least one of the HVAC module 108, the seat module 112, the A/V module 116, and the lighting module 120 notifying the modules that the external device 100 associated with the user is in the vicinity of the vehicle 10. As mentioned, the list of modules provided in FIG. 2 is exemplary and are not intended to limit the modules that may be incorporated. Each of the HVAC module 108, the seat module 112, the A/V module 116, and the lighting module 120 has a data store corresponding thereto. The HVAC module 108 has an HVAC module datastore 110, the seat module 112 has a seat module datastore 114, the A/V module 116 has an A/V module datastore 118, and the lighting module 120 has a lighting module 120 datastore. In an exemplary embodiment, the HVAC module datastore 110, the seat module datastore 114, the A/V module datastore 118, and the lighting module 120 are comprised of EEPROM which is accessible to the respective module.

Each datastore stores parameter values relating to the user's personal settings. For instance, the HVAC module datastore 110 is organized such that one or more settings of the HVAC are associated with an external device 100 or the associated user of the external device 100. For instance, a user may have a preferred temperature, fan speed, fan location, or other HVAC related settings stored in the HVAC module datastore 110, whereby the personal settings are related to the external device 100 or the user associated thereto. Each of these settings may have a value such that when retrieved by the HVAC module 108, the HVAC module 108 can determine what adjustments to make to the HVAC system 40 of the vehicle 10. Once the HVAC module 108 receives notification that an external device 100 and/or the user is in the vicinity of the vehicle 10, the HVAC module 108 will retrieve the HVAC settings associated with the user from the HVAC module datastore 110 and will adjust the HVAC system 40 in accordance with the settings. As discussed above, multiple users may drive the vehicle 10 so the HVAC module datastore 110 may store HVAC settings associated with multiple users or devices.

The seat module 112 controls the settings of the driver's seat 50 and optionally the other seats in the vehicle 10. When the seat module 112 receives notification that the external device 100 and/or the user is in the vicinity of the vehicle 10, the seat module 112 will retrieve the user's personal seat settings from the seat module datastore 114. The user's personal seat settings can include but are not limited to the height of the seat 50, the firmness of the seat 50, the angle of the seat 50 back, the angle of the seat 50 back, and the distance of the seat 50 from the steering wheel. Once the seat module 112 retrieves the user's personal seat settings the seat module 112 will transmit a signal to a seat actuator (not shown) to adjust the settings of the driver seat 50 in accordance with the user's personal seat settings.

The A/V module 116 controls the settings of the vehicle's audio/visual system. The audio/visual system can be a radio, a radio with a touch screen, a radio with a navigation system, or any other audio visual system suitable for a vehicle 10. When the A/V module 116 receives notification that the external device 100 or the user is in the vicinity of the vehicle 10, the AV module 116 will retrieve the user's personal A/V settings from the A/V storage module 118. The A/V settings may include playlists, volume control, preferences on the display, the manner in which the user interface 122 is displayed, the amount of data displayed on the screen of the audio visual system, stored radio stations, and other A/V system 30 related data. Once the A/V module 116 retrieves the stored settings from the NV storage module 118, the A/V module 116 restores the settings of the audio/visual system according to the user's personal A/V settings. While the foregoing description provides a description of an audio/visual system, it is appreciated that the foregoing applies to an audio system as well.

The lighting module 120 controls the settings for the vehicle's lighting system. The lighting system can control the interior and/or exterior lights of the vehicle 10. When the lighting module 120 receives notification that the external device 100 or the user is in the vicinity of the vehicle 10, the lighting module 120 will retrieve the user's personal lighting settings from the lighting module data store 122. The lighting settings may include colors of lights, which lights turn on when a door is opened, the duration that the lights remain on after the vehicle 10 has been turned off, and other lighting related settings. Once the lighting module 120 retrieves the stored settings from the lighting module data store 122, the lighting module 120 restores the settings of the lighting system according to the user's personal lighting settings.

It is envisioned that other vehicle components can be controlled in the manner described above.

As shown, the user settings system 102 further includes a user interface 122. The user interface 122 allows a user to interact with a component of the vehicle 10. Most notably the user interface 122 may be integrated into the audio/visual system of the vehicle 10, whereby a user can enter commands via an input device of the audio visual system, e.g. a touch screen on the radio of the vehicle 10. When a user desires to store a setting, the user interface 122 displays a screen that prompts the user to store the current setting or settings. For instance, if a user changes the settings of the seat 50, the user interface 122 displays a screen to the user asking whether the user would like the vehicle 10 to remember the seat settings. If the user responds affirmatively, the seat module 112 stores parameter values indicative of the current seat settings in the seat module datastore 114. It is appreciated that the user interface 122 can be further configured such that the user can enter preferred user settings for various components of the vehicle 10 via the user interface 122. For instance, the user interface 122 can display various components which the user can select from. Once the user selects a particular component, the user can enter preferred settings via the user interface 122, or the controls of the vehicle component.

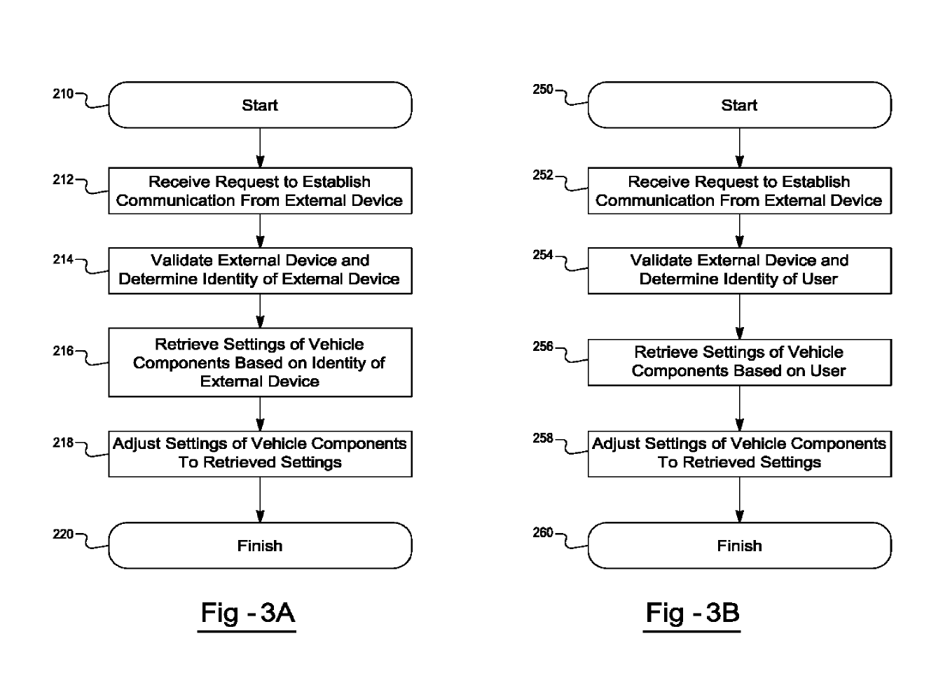

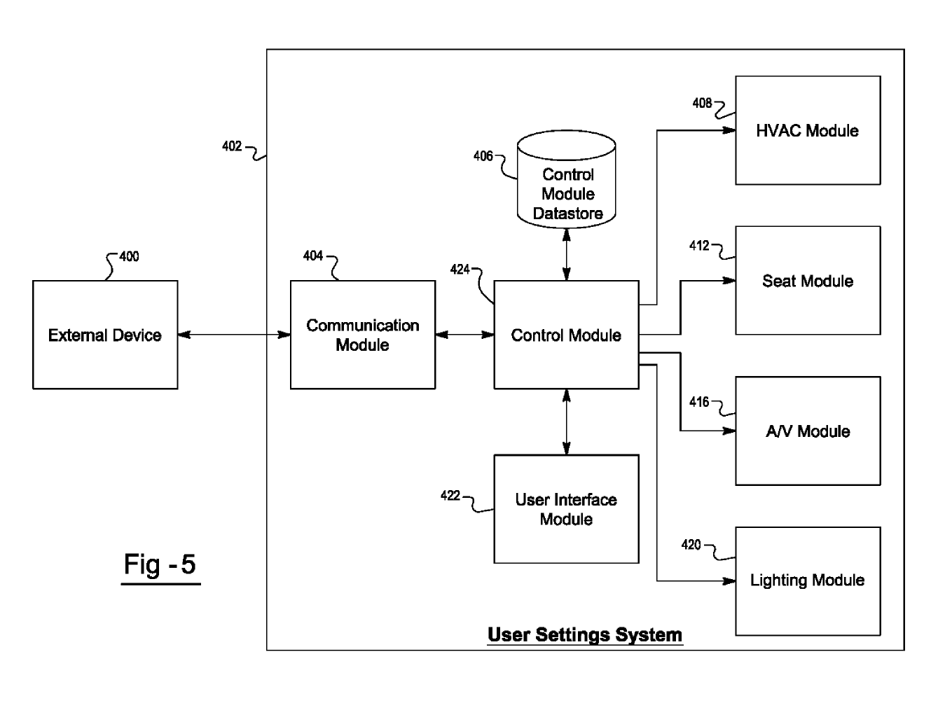

FIG. 3A illustrates an exemplary method for restoring a user's personal settings, which is executed by the user settings system 102. As discussed above, the communications module 104 can detect a discoverable external device 100 and broadcast to the device 100 that a connection is possible. If a device is not discoverable, the external device 100 will initiate a connection. In either scenario, the external device 100 will transmit a request to establish a communications link between the communications module 104 of the vehicle 10 and the external device 100 associated with a user of the vehicle 10 from the external device 100, as shown at step 212. The request will include a key and a device identifier. Once the communications module 104 receives the request to establish a communications link, the communications module 104 will verify/authenticate the external device 100 by checking the communications module datastore 106, as shown at step 214. The communications module 104 will verify that a device having the received device identifier and key is represented in the communications module datastore 106. If so, the communications module 104 will establish a communications link with the external device 100. Further, in the configuration shown in FIG. 2, the communications module 104 will communicate the device identifier or an indicator thereof to the various vehicle components. Based on the device identifier, the vehicle components will retrieve the personal settings associated with the device identifier from an associated datastore, as shown at step 216. Alternatively and as will be discussed with respect to FIG. 5, the device identifier can be communicated to a control module 424, which retrieves the settings for the various components from a control module datastore 426 and will communicate the personal settings associated with the device identifier to the corresponding vehicle components. Once a vehicle component has received the personal settings, the vehicle component module will adjust the settings of the vehicle component in accordance with the personal settings associated with the device, as shown at step 218. It is appreciated that in some embodiments, the user interface 122 may prompt the user to verify that the user desires to have the settings restored by the various vehicle components.

FIG. 3B illustrates a variation of the method shown in FIG. 2A. According to the method illustrated in FIG. 2B, a user identifier is used to retrieve the settings rather than a device identifier. In these embodiments, a user can be associated with one or more devices. For instance, if a user has a personal mobile telephone, a laptop, and a work related mobile telephone, all three external devices 100 can be registered to the user. When the communications module 104 receives a request to establish a communications link with one of the listed external devices 100, the communications module 104 will retrieve a user identity associated with the device identifier of the external device 100 requesting a communications link, as shown at step 254. The user identity can be communicated to the various vehicle components (FIG. 2) or a control module (FIG. 5). Based on the user identity, the preferred user settings are retrieved from the data stores of the vehicle components (FIG. 2) or from a control module datastore (FIG. 5), as shown at step 256. The various vehicle components will then adjust the respective settings in accordance with the stored personal settings associated with the user, as shown at step 258. It is appreciated that in some embodiments, the user interface 122 may prompt the user to verify that the user desires to have the settings restored by the various vehicle components.

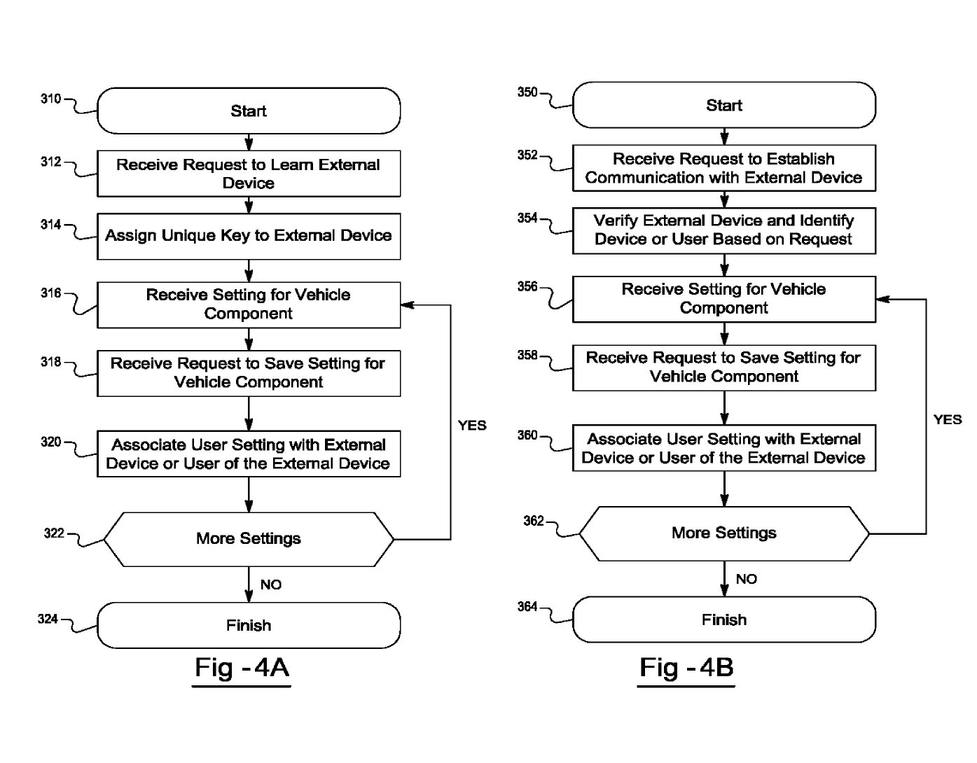

FIG. 4A illustrates a method that is executed by an exemplary user settings system when registering a new external device 100 or user. As discussed above, the communications module 104 learns a device for later communication, as shown at step 312. In the context of a Bluetooth® receiver, the communications module 104 will pair with the device 100. Pairing with the device includes generating and assigning a unique key to the external device 100, as shown at step 214. The communications module 104 will communicate the key to the device 100 and the device 100 will verify the key by transmitting the key back to the communications module. Once the key is assigned to the device 100, the communications module stores the key, as well as a device identifier and/or a user identifier in a datastore.

Once a device identifier or user has been associated with the external device 100, the user settings system 102 can begin storing settings corresponding to the external device 100. This can occur in any suitable fashion. For instance, the user can set various settings in the vehicle 10, as shown at step 316 and can command the user settings system to store the settings, as shown at step 318, via the user interface 122. Alternatively, the user can be prompted by the user interface 122 to set his or her personal settings. Once the user has entered a setting for a vehicle component, the user can be prompted by the user interface 122 to determine if a particular setting should be saved. If the user responds affirmatively, the user's personal setting is stored in a datastore, as shown at step 318. Further, the user's personal setting is associated with the device identifier or a user identifier, as shown at step 320. This can be achieved by relating a parameter value indicative of the setting being stored to the device identifier or the user identifier in the data store. If more settings remain, the method will continue to execute, as shown at step 322. If, however, the user does not wish to store any more settings, the method ends, as shown at step 324.

FIG. 4B illustrates an exemplary method that is executed by the user settings system after a device has been learned by the user settings system. As can be appreciated, a user may opt to change or add his or her personal settings after some time. As discussed above, the external device 100 will request to establish a communications link, and the communications module 104 will receive the request and verify and/or authenticate the external device 100, as shown at steps 352 and 354. The user at any given time may opt to change the settings of one or more of the vehicle components, as shown at step 356. If the user does so, the user may be prompted by the user interface 122 to indicate if the adjusted settings of the one or more vehicle components are to be saved. If the user responds affirmatively, the adjusted settings are saved in a datastore associated with the vehicle component, as shown at step 358. Further, the new settings are associated with the device identifier or the user identifier in the datastore for later retrieval, as shown at step 358. If the user has changed more than one setting, the method continues to reiterate, as shown at step 362, until no more settings are to be saved. Once there are no more settings to be saved, the method will stop executing, as shown at step 364.

It is appreciated that the methods explained above are exemplary, and variations thereof are further contemplated.

FIG. 5 illustrates an alternative configuration of a user settings system 402. In this configuration, the communications module 404 communicates with a control module 424, which is coupled to a central data store 406. The central data store stores data for validating and/or authenticating a device, the value parameters associated with the various devices or users having preferred settings stored, and any other data used by the user settings system 402. In these embodiments, the communications module 404 receives a request to establish a communications link from an external device 400, including a key and a device identifier. The communications module 404 communicates the key and the device identifier to the control module 424, which verifies and/or authenticates the device by checking for the key/device combination in the central data store 406. Once the external device 400 is verified/authenticated, the control module 424 notifies the communications module 404 that a communications link can be established. Further, the control module 424 retrieves the preferred user settings of the user from the central data store 406. The control module 424 then communicates the preferred user settings to the appropriate vehicle component modules, e.g. the HVAC module 408, the seat module 412, the A/V module 416, and the lighting module 420. It is appreciated that the control module 424 communicates with the communications module and the various vehicle component modules via a communications bus.

As can be appreciated, a plurality of users may use the vehicle 10. Thus, the user settings system can be configured to resolve conflicts if more than one external device 100 is detected in the vehicle. One way is to rank the devices by the order in which they were registered. Thus, an earlier registered device is given priority over a newer device. Another way to rank the devices is to have the user provide an order for the devices. This can be entered using the user interface 122. In either scenario, a priority list can be stored in a computer readable medium associated with the user settings system such that when two devices are encountered priority is initially given to the device having a higher priority. Additionally or alternatively, the user interface 122 can present the user with a list of detected devices/users and the user can select a device/user from the plurality of listed devices/users. This can be done via the user interface 122 or by voice command.

The following description is merely illustrative in nature and is in no way intended to limit the disclosure, its application, or uses. It should be understood that steps within a method may be executed in different order without altering the principles of the present disclosure. The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

As used herein, the term module may refer to, be part of, or include an Application Specific Integrated Circuit (ASIC); an electronic circuit; a combinational logic circuit; a field programmable gate array (FPGA); a processor (shared, dedicated, or group) that executes code; other suitable components that provide the described functionality; or a combination of some or all of the above, such as in a system-on-chip. The term module may include memory (shared, dedicated, or group) that stores code executed by the processor.

The term code, as used above, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The apparatuses and methods described herein may be implemented by one or more applications executed by one or more processors. The applications include processor-executable instructions that are stored on a non-transitory tangible computer readable medium. The applications may also include stored data. Non-limiting examples of the non-transitory tangible computer readable medium are nonvolatile memory, magnetic storage, and optical storage.

What is claimed is:

1. A method for reinstating settings of at least one vehicle component of a vehicle, the method comprising:
receiving a request to establish a communications link between a communications module of the vehicle and an external device associated with a user of the vehicle from the external device;
retrieving settings of the at least one vehicle component of the vehicle from a data store associated with the at least one vehicle component based on the request to establish the communications link, wherein the data store resides in the vehicle; and
adjusting the settings of the at least one vehicle component based on the retrieved settings.

2. The method of claim 1 further comprising determining an identity of the user from the request to establish the communications link and retrieving the settings of the at least one vehicle component vehicle from the data store based on the identity of the user.

3. The method of claim 2 further comprising associating a current setting of the at least one vehicle component to the identity of the user, associating the external device to the user, and storing the current setting in the data store such that the current setting corresponds to the user.

4. The method of claim 1 further comprising determining an identity of the external device from the request to establish the communications link and retrieving the settings of the at least one vehicle component from the data store based on the identity of the external device.

5. The method of claim 4 further comprising associating a current setting of the at least one vehicle component to the determined identity of the external device and storing the current setting in the data store such that the current setting corresponds to external device.

6. The method of claim 4 wherein the identity of the external device is determined from a key assigned to the external device by the communications module, and wherein the key is communicated by the external device to the communications module in the request to establish communication.

7. The method of claim 1 wherein the external device is one of a mobile telephone, a personal digital assistant, a laptop computer and a MP3 player.

8. The method of claim 1 wherein the communications link is a Bluetooth connection and the request to establish a communications link is a request to synchronize the external device with the communications module.

9. The method of claim 1 wherein the at least one vehicle component includes at least one of a driver seat, an HVAC system, an audio visual system, and a lighting system.

10. A user settings system for reinstating settings of at least one vehicle component of a vehicle, comprising:
a communications module that receives a request to establish a communications link between the communications module and an external device associated with a user of the vehicle from the external device, and that establishes the communications link between the communications module and the external link; and
at least one component module that retrieves settings of the at least one vehicle component of the vehicle from a data store associated with the at least one component module based on the request to establish the communications link and that adjusts the settings of the at least one vehicle component based on the retrieved settings, wherein the data store resides in the vehicle.

11. The system of claim 10 wherein the communications module determines an identity of the user from the request to establish the communications link and the at least one component module retrieves the settings of the at least one vehicle component vehicle from the data store based on the identity of the user.

12. The system of claim 11 wherein the communications module associates a current setting of the at least one vehicle component to the identity of the user, associates the external device to the user, and stores the current setting in the data store such that the current setting corresponds to the user.

13. The system of claim 10 wherein the communications module determines an identity of the external device from the request to establish communication and retrieves the settings of the at least one vehicle component vehicle from the data store based on the identity of the external device.

14. The system of claim 13 wherein the communications module associates a current setting of the at least one vehicle component to the identity of the external device and stores the current setting in the data store such that the current setting corresponds to external device.

15. The system of claim 13 wherein the identity of the external device is determined from a key assigned to the external device by the communications module, and wherein the key is communicated by the external device to the communications module in the request to establish communication.

16. The system of claim 10 wherein the external device is one of a mobile telephone, a personal digital assistant, a laptop computer and a MP3 player.

17. The system of claim 10 wherein the communications link is a Bluetooth connection and the request to establish a communications link is a request to synchronize the external device with the communications module.

18. The system of claim 10 wherein the at least one vehicle component is at least one of a driver seat, an HVAC system, an audio visual system, and a lighting system.
